(19) United States
(12) Patent Application Publication
(10) Pub. No.: US 2010/0277092 A1
(43) Pub. Date: Nov. 4, 2010

(54) LOW-DROPOUT (LDO) CURRENT REGULATOR

(75) Inventors: Michele Menegazzi, Paese (Treviso) (IT); Matteo Toscan, Maser (Treviso) (IT)

Correspondence Address: Viering, Jentschura & Partner - OSR, 3770 Highland Ave., Suite 203, Manhattan Beach, CA, 90266, US

(73) Assignee: OSRAM GESELLSCHAFT MIT BESCHRAENKTER HAFTUNG, Muenchen (DE)

(21) Appl. No.: 12/772,255

(22) Filed: May 3, 2010

(30) Foreign Application Priority Data
May 4, 2009 (IT) TO2009A000357

(51) Int. Cl. H05B 37/02; G05F 1/10

(52) U.S. Cl. 315/291; 323/265

(57) ABSTRACT

Various embodiments provide a driver device, which may include a transistor for providing a regulated current, said transistor having a control electrode; and a stabilization circuit acting on said control electrode of said transistor to produce a stabilized reference value for said current; a bipolar transistor coupled to said control electrode of said transistor in a feedback relationship, whereby, with said bipolar transistor conducting, increase and decrease of said current induce decrease and increase of the collector current in said bipolar transistor, respectively; and interposed between the base and the emitter of said bipolar transistor, a cascade arrangement of a diode and a resistance sensitive to said current so that said stabilized reference value for said current is determined by the value of said resistance as a function of the difference between the base-emitter voltage of said bipolar transistor and the voltage across the anode and cathode of said diode.

### CROSS-REFERENCE TO RELATED APPLICATION

This application claims priority to Italian Patent Application Serial No. TO2009A000357, which was filed May 4, 2009, and is incorporated herein by reference in its entirety.

### TECHNICAL FIELD

This disclosure relates to low-dropout (LDO) current linear regulators.

### BACKGROUND

LDO regulators are used in a wide range of applications in the electronic sector, with the aim to apply a signal, regulated as a function of a reference signal, to a load.

This disclosure was devised with specific attention paid to its possible application to linear regulators for the driving current of light sources such as, for instance, light emitting diodes (LEDs).

In backlighting applications, discharge lamps (or fluorescent lamps) have been recently widely substituted with LED lighting modules. Such lighting modules may include several printed circuit boards PCBs, each of them with one or more LEDs, the boards being interconnected via wires or cables so as to be flexible and adapted to fit in illuminated signs with shaped channel letters, that normally require custom light sources or adaptable systems, as in the present case. The high number of units (or modules) connected in parallel requires a low-cost driving solution.

The current linear regulator according to the diagram in FIG. 1 is an example of a solution currently adopted for the purpose.

In this example, that relates to the driving of two diodes LED connected in series, and respectively denoted by LED1 and LED2, the device includes two bipolar transistors (BJT), in this case of a pnp type, denoted by the references T1 and T2, and two resistances R1 and R2.

Referring to FIG. 1, the positive terminal of a generator VDC1 of an input dc voltage is connected with the emitter E1 of the first transistor T1 (node A). Resistance R1 is connected between the emitter E1 and the base B1 of the first transistor T1. The base B1 is moreover connected with the emitter E2 of the second transistor T2 (node C). The collector C1 of the first transistor T1 is connected, through node D, to the base B2 of the second transistor T2. Resistance R2 is connected between node D and node B, i.e. the negative terminal of the voltage generator VDC1. The collector C2 of the second transistor T2 supplies the series of both LED1 and LED2. Finally, the cathode of the second diode LED2 is connected to the above mentioned node B on the second supply line 20.

In operation, the high-impedance resistance R2 biases the first transistor T1 with a very low collector current Ic (μA), but the base-emitter voltage V_{BE1} of the first transistor T1 is set to the value V_{BEon}.

The value I_{LED} of the current flowing in the load (here represented, by way of example, by both diodes LED1 and LED2) is the same as the collector current I_{C2} of transistor T2, which in turn is approximately equal to the emitter current I_{E2} of the same transistor, and it is therefore determined, through resistance R1, by the value of the voltage drop between the emitter and the base (reference voltage V_{BE1}) of transistor T1, according to the following relation:

$${I}_{LED} = {I}_{C 2} \approx {I}_{E 2} = \frac{{V}_{BE 1}}{{R}_{1}}$$

In the driver of FIG. 1, transistor T2 is therefore used as a LED driver circuit, while transistor T1 performs a stabilization function.

The collector current I_{C2} of the driver transistor T2 drives the light sources LED1 and LED2, and the stabilization circuit T1, R1, R2 produces a reference voltage V_{BE1}—which is stable with reference to the input voltage VDC1—which, being applied to transistor T2, also makes the current I_{LED} flowing across the LEDs stabilized with reference to the input voltage VDC1. A stabilization of the current I_{LED} with reference to the input voltage VDC1 is therefore achieved.

The desired value for the current I_{LED} can therefore be defined by choosing a value for resistance R1.

The typical voltage value between emitter and base for bipolar transistors operating with direct biasing approximately amounts to 0.7 V.

One may therefore consider, by way of reference only, a first numerical example wherein:
the input direct current, produced by generator VDC1, amounts to 10 volt DC (10 V_{DC}), and
the load, consisting of both diodes LED arranged in series, is made up of InGaN (indium gallium nitride) LEDs; in this case, the maximum direct voltage applicable to each LED in rated current conditions is equal to 4.2 V.

In this case, i.e. with a direct voltage on the load amounting to 2×4.2 V=8.4 V, the circuit requires a very low regulation voltage, of the order of 1.4 V. This voltage amounts to the sum of the voltage drop between emitter and base of the first transistor T1 VEB1=0.7V (which is equal to the voltage drop on resistance R1 VEB1=VR1) and of the voltage drop between emitter and base of the second transistor T2 VEB2=0.7V, because, for a correct current regulation, VEC2≧VBE2=0.7V (rated values).

In order to ensure an adequate speed of reaction to the changes of input voltage VDC1, and in order to avoid current peaks that may damage the load, consisting of a light source comprising two diodes LED connected in series, transistor T2 operates outside the saturation state.

Specifically, if the voltage VBC2 between the base and the collector of the second transistor T2 is higher than zero, then the voltage drop VEC2 between emitter and collector of the same transistor T2, which in turn is given by the sum of the emitter-base voltage VEB2 with the base-collector voltage VBC2, always of the second transistor T2, becomes higher than 0.7V.

One may consider, always by way of reference only, a second numerical example, wherein the input voltage amounts to 12V_{DC}, and the load is made of gallium nitride LEDs, obtained through thin film technology (ThinGaN). In this case, in order to increase the operating efficiency, the load will include at least three LEDs connected in series.

The direct voltage of gallium nitride LEDs obtained through thin-film technology (ThinGaN), in a state of rated current, amounts to 3.8V. As a consequence, in the worst case, the voltage drop on the load equals 3.8V=11.4V.

With the driving solution of FIG. 1, the drop-out voltage amounting to 1.4V is too high, and the circuit might not work correctly.

### SUMMARY

Various embodiments provide a driver device, which may include a transistor for providing a regulated current, said transistor having a control electrode; and a stabilization circuit acting on said control electrode of said transistor to produce a stabilized reference value for said current; a bipolar transistor coupled to said control electrode of said transistor in a feedback relationship, whereby, with said bipolar transistor conducting, increase and decrease of said current induce decrease and increase of the collector current in said bipolar transistor, respectively; and interposed between the base and the emitter of said bipolar transistor, a cascade arrangement of a diode and a resistance sensitive to said current so that said stabilized reference value for said current is determined by the value of said resistance as a function of the difference between the base-emitter voltage of said bipolar transistor and the voltage across the anode and cathode of said diode.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 has been previously described; and

FIG. 2 shows a circuit diagram representative of an embodiment of the solution described herein.

### DESCRIPTION

The following detailed description refers to the accompanying drawings that show, by way of illustration, specific details and embodiments in which the invention may be practiced.

In the following description, numerous specific details are given to provide a thorough understanding of embodiments. The embodiments can be practiced without one or more of the specific details, or with other methods, components, materials, etc. In other instances, well-known structures, materials, or operations are not shown or described in detail to avoid obscuring aspects of the embodiments.

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The headings provided herein are for convenience only and do not interpret the scope or meaning of the embodiments.

The claims are an integral part of the disclosure of the invention provided herein.

Various embodiments provide a low-dropout current regulator, for example for driving light sources, such as LEDs (Light Emitting Diodes), adapted to perform a current linear regulation with low drop-out, for example for driving a high number of light sources.

Various embodiments provide a device of this kind.

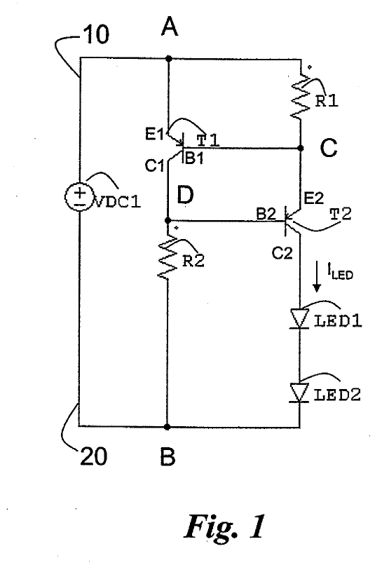

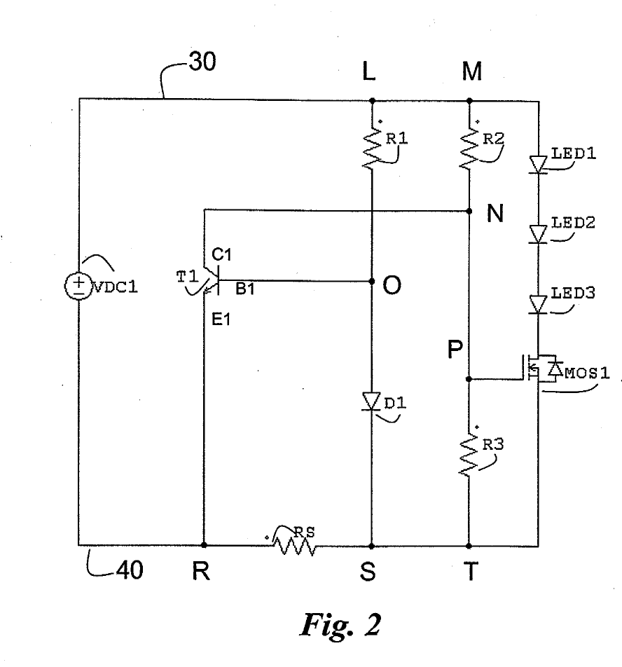

In FIG. 2 the parts, elements or components identical or equivalent to parts, elements or components previously described with reference to FIG. 1 are denoted by the same references, making it unnecessary to repeat the description thereof.

Also FIG. 2 shows a driver device with current linear regulation, wherein, in the same way as in FIG. 1, a transistor is provided (e.g. a metal-oxide-semiconductor field-effect transistor (MOSFET), here of the p-channel type) denoted by reference MOS1, used as a LED driver circuit, while a transistor T1 (obtained by using a bipolar transistor (BJT), here of a npn type) performs a stabilization function.

In the presently discussed embodiment, the circuit moreover may include a diode D1 and four resistances R1, R2, R3 and RS.

In this case, the circuit is also assumed to be adapted to drive a load consisting of a light source comprising three LED diodes connected in series, denoted by LED1, LED2 and LED3. For example, they can be three gallium nitride LEDs, obtained by thin-film technology (ThinGaN), with a voltage drop on each LED, in rated current conditions, amounting to approximately 3.8V, i.e. with a total voltage drop on the related load amounting to 3×3.8V=11.4V. In other words, the operating conditions cannot be tackled, as previously discussed, with the regulator in FIG. 1.

It is however obvious that the range of applicability of the solution considered herein with reference to FIG. 2 is not limited to this particular context.

Always referring to FIG. 2, the positive terminal of the supply source VDC1 is connected to a first supply line 20. Resistance R1 is arranged between said first supply line 30 (node L) and the base B1 of transistor T1 (node O). Base B1 is moreover connected to the anode of diode D1, for example a Schottky diode.

Resistance RS is interposed between the cathode of diode D1 (node S) and the emitter E1 of transistor T1 (node R), and it performs the function of amperometric resistance for sensing the current flowing across the load, i.e. across the diodes LED1, LED2 and LED3.

Emitter E1 is moreover connected, through a common node R, to a second supply line 40, leading to the negative terminal of the voltage generator VDC1.

Resistance R2 is interposed between the first supply line 30 (node M) and the collector C1 of the transistor T1 (node N). Node P, coincident with node N, is connected to the Gate terminal of transistor MOS1.

Resistance R3 as well is connected to node P, and the other terminal is connected, through a node T, to the common node S, to which the cathode of diode D1 and the sensing resistance RS are connected. The common node T is moreover connected to the Source terminal of transistor MOS1.

In the presently considered example, the diodes LED1, LED2 and LED3 are connected in a series arrangement with the anode of LED1, connected to node M, while the cathode of LED3 is connected to the Drain terminal of transistor MOS1; therefore the LEDs are traversed by a current which is equal to the Drain current of transistor MOS1.

With this arrangement, the voltage drop VD1 at the ends of diode D1, set by the resistance R1, identifies the stable reference voltage of the circuit, which will be applied (as it will be best seen in the following) to transistor MOS1, operating as a load driver transistor.

In the presently discussed circuit, the voltage drop VD1 at the ends of diode D1 is lower than the base-emitter voltage of transistor T1, and therefore, when the circuit is ignited, transistor T1 is initially off.

In an embodiment, in order to achieve this result it is possible to use, as the diode D1, a Schottky diode with a threshold voltage VD1, selected so as to be half the base-emitter threshold voltage VBE of transistor T1,

$$i . e . VD 1 = \frac{VBEon}{2} = 0.35 V .$$

In order that the voltage drop VD1 at the ends of diode D1 is lower than the base-emitter voltage VBE of transistor T1, it is however (also) possible to make use of the presence of resistance RS. The presence of RS causes a voltage drop VRS on RS; consequently, in the mesh formed by T1, D1 and RS, VBE equals the sum of VD1 and VRS. Therefore, because VRS cannot be negative, VD1 is always lower than or equal to VBE.

The biasing resistances R2 and R3 are chosen in such a way as to set the Gate-Source voltage VGS of transistor MOS1 so as to ensure, within the whole variation range of input voltage VDC1, the lowest resistance RDSon (i.e. the resistance which, in a saturated state, the transistor opposes to the current flow between Drain and Source).

At ignition, if it is reasonably assumed that current ID1 flowing across diode D1 and current IR3 flowing across resistance R3 are negligible, the current in the load, i.e. in the LEDs, denoted by I_{LED}, is given by:

$${I}_{LED} = \frac{{V}_{DC 1} - {V}_{LED} - {V}_{DS}}{Rs} .$$

Moreover, the voltage drop VBE1 between the base and the emitter of transistor T1 equals the voltage drop VD1 on diode D1, V_{BE1}=V_{D1}, because transistor T1 is initially off, as VD1 has been chosen to be lower than the transistor threshold voltage.

The voltage between Gate and Source of transistor MOS1 is set to be higher than VT through the choice of the resistances R2 and R3, so as to ensure that MOS1 is on and that current flows through Drain and Source.

The current ILED produces a voltage drop on Rs, that raises VBE of T1 (VBE=VD1+VRS) until it reaches the ignition VBE of T1. Across T1 an increasing current Ic starts to flow, that consequently decreases the voltage at node N, and therefore the Gate-Source voltage. The voltage between Gate and Source VGS decreases until a steady state or balance condition is obtained, wherein

V_{BE}V_{D1}+V_{RS}=V_{D2}+I_{LED}·R_{S}

with transistor T1 conducting.

Stabilization takes place because initially I_{LED}, which approximately corresponds to IRS, produces a voltage drop on RS, and VBE increases until T1 is conducting.

With the transistor T1 on, the current I_{c} that flows in the collector of transistor T1 increases, the voltage at node N decreases and therefore the voltage VGS between Gate and Source of MOSFET MOS1 also falls, and in this way the current decreases through MOS1.

Similarly, if the current I_{c} flowing in the collector of transistor T1 should decrease, the voltage at node N would rise, and therefore the voltage VGS between Gate and Source of MOSFET MOS1 would increase. This would cause a higher current I_{LED} on the load, i.e. in the LEDs, due to a higher current flowing across transistor MOS1.

When the bipolar transistor (T1) is conducting, this feedback control allows the rise and the fall of the regulated current I_{LED} that respectively induce a rise and a fall of the collector current of the bipolar transistor (T1).

Substantially, when Ic increases, VR2 increases (or, better expressed, the potential at node N decreases), and therefore VR3 (Gate-Source voltage) falls, I_{LED} decreases, and the effect is a decrease of Ic; conversely, the contrary effect is achieved when Ic decreases, i.e. node N rises, VR3 rises and therefore I_{LED} rises, causing an increase of IC. This mechanism leads to the stabilization of IC and of I_{LED}, which will be defined by:

V_{BE}=V_{D1}+V_{RS}=V_{D1}+I_{LED}·R_{S}.

This feedback control is stabilized when the voltage VBEon between base and emitter of transistor T1 reaches the threshold value VBE

V_{Beon}=V_{BE}=V_{D1}+V_{RS}=V_{D1}+I_{LED}·R_{S}

By knowing the values of the voltage drop VBEon between base and emitter of transistor T1 and the voltage drop V_{D1} on diode D1, it is possible to regulate the value of the current I_{LED} flowing across the load, by selecting the value of resistance R_{S}:

$${R}_{s} = \frac{{V}_{BEon} - {V}_{D 1}}{{I}_{LED}} .$$

The overall voltage drop of the regulator as a whole is given by:

V_{DROP}=V_{R}_{_{S}}+V_{DS}=I_{LED}R_{S}+V_{DS}.

If a diode D1 is chosen with a value of V_{D1} proximate the value of the base-emitter voltage V_{BEon}, the voltage drop VR_{S} on resistance RS is lower, and therefore the overall voltage drop V_{DROP} will be smaller as well.

In the above discussed example, the minimum overall voltage drop V_{DROP} on the voltage regulator is therefore given by 0.35V+0.05V=0.4V, wherein 0.05V is the minimum voltage V_{DSon} necessary to avoid saturation problems.

Although not being a compulsory choice, using a MOSFET transistor instead of a bipolar transistor (BJT) as a driver transistor leads to a lower voltage drop and to an excellent dynamic behaviour. As a consequence of the variation of the input voltage, a BJT transistor could enter the saturation range and produce undesirable current peaks, going from saturation to the active mode.

Considering that the driver transistor (in the present case the MOSFET MOS1) may also be, at least in principle (as in the case of FIG. 1), a bipolar transistor, the terms “source”, “gate” and “drain” as used herein and referring the FET technology, are therefore to be understood as being applicable as well, without limitations, to the terms “emitter”, “base” and “collector”, that denote the equivalent elements of a bipolar transistor. Specifically, the phrase “control electrode”, as it is used in the claims, refers indifferently both to the gate of a FET and to the base of a BJT transistor (i.e. to point P in FIG. 2).

The regulator described herein can be applied both to LEDs other than the ones that have been discussed by way of example, and to light sources other than LED modules, and also to electrical loads other than light sources.

Without prejudice to the underlying principles of the invention, the details and the embodiments may vary, even appreciably, with respect to what has been described by way of example only, without departing from the scope of the invention as defined by the annexed claims. For example, as previously mentioned, it will be appreciated that the presently described solution is generally adapted to be used for obtaining a low-drop current regulator for applications other than the driving of light sources.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A driver device to produce a regulated current from an input voltage, the driver device comprising:
a driver transistor for providing said regulated current, said driver transistor having a control electrode; and
a stabilization circuit acting on said control electrode of said driver transistor to produce, from said input voltage, a stabilized reference value for said regulated current;
a bipolar transistor coupled to said control electrode of said driver transistor in a feedback relationship, whereby, with said bipolar transistor conducting, increase and decrease of said regulated current induce decrease and increase of the collector current in said bipolar transistor, respectively; and
interposed between the base and the emitter of said bipolar transistor, a cascade arrangement of a diode and a resistance sensitive to said regulated current so that said stabilized reference value for said regulated current is determined by the value of said resistance as a function of the difference between the base-emitter voltage of said bipolar transistor and the voltage across the anode and cathode of said diode.

2. The device of claim 1,
wherein said driver transistor is a field effect transistor, wherein the control electrode of said driver transistor is the gate of the field effect transistor.

3. The device of claim 1,
wherein said diode is selected with a threshold voltage value proximate the value of the base-emitter voltage of said bipolar transistor.

4. The device of claim 1,
wherein said diode is selected with a threshold voltage value equal to about ½ the value of the base-emitter voltage of said bipolar transistor.

5. The device of claim 1,
wherein said diode is a Schottky diode.

6. The device of claim 1,
wherein said resistance is a resistance traversed by said regulated current, wherein said stabilized reference value for said regulated current is determined by the ratio between:
the difference between the base-emitter voltage of said bipolar transistor and the voltage between the anode and cathode of said diode and
the value of said resistance.

7. The device of claim 1,
wherein said bipolar transistor and said control electrode of said driver transistor are referred to at least one common bias resistance to receive said input voltage,
whereby decrease and increase of the collector current of said bipolar transistor induce increase and decrease of the voltage on said control electrode of said driver transistor, respectively.

8. The device of claim 1,
wherein the collector of said bipolar transistor and said control electrode of said driver transistor are connected to each other.

9. The device of claim 1,
wherein said driver transistor has coupled thereto a light source driven by said regulated current.

10. The device of claim 9,
wherein the light source comprises an LED light source.

11. A driver device to produce a regulated current from an input voltage, the driver device comprising:
a driver transistor for providing said regulated current, said driver transistor having a control electrode; and
a stabilization circuit acting on said control electrode of said driver transistor to produce, from said input voltage, a stabilized reference value for said regulated current;
a field effect transistor coupled to said control electrode of said driver transistor in a feedback relationship, whereby, with said field effect transistor conducting, increase and decrease of said regulated current induce decrease and increase of the drain current in said field effect transistor, respectively; and
interposed between the gate and the source of said field effect transistor, a cascade arrangement of a diode and a resistance sensitive to said regulated current so that said stabilized reference value for said regulated current is determined by the value of said resistance as a function of the difference between the gate-source voltage of said field effect transistor and the voltage across the anode and cathode of said diode.

12. The device of claim 11,
wherein said driver transistor is a field effect transistor, wherein the control electrode of said driver transistor is the gate of the field effect transistor.

13. The device of claim 11,
wherein said diode is selected with a threshold voltage value proximate the value of the gate-source voltage of said field effect transistor.

14. The device of claim 11,
wherein said diode is selected with a threshold voltage value equal to about ½ the value of the gate-source voltage of said field effect transistor.

15. The device of claim 11,
wherein said diode is a Schottky diode.

16. The device of claim 11,
wherein said resistance is a resistance traversed by said regulated current, wherein said stabilized reference value for said regulated current is determined by the ratio between:
the difference between the gate-source voltage of said field effect transistor and the voltage between the anode and cathode of said diode and
the value of said resistance.

17. The device of claim 11,
wherein said field effect transistor and said control electrode of said driver transistor are referred to at least one common bias resistance to receive said input voltage, whereby decrease and increase of the drain current of said field effect transistor induce increase and decrease of the voltage on said control electrode of said driver transistor, respectively.

18. The device of claim 11,
wherein the drain of said field effect transistor and said control electrode of said driver transistor are connected to each other.

19. The device of claim 11,
wherein said driver transistor has coupled thereto a light source driven by said regulated current.

20. The device of claim 19,
wherein the light source comprises an LED light source.
